(19) United States
(12) Patent Application Publication
(10) Pub. No.: US 2023/0138625 A1
(43) Pub. Date: May 4, 2023

(54) METHOD FOR DETECTING EMITTED LIGHT FROM DISPLAY SCREEN AND DISPLAY APPARATUS

(71) Applicant: EIZO Corporation, Hakusan-shi, Ishikawa (JP)

(72) Inventors: Akinori HAYASHI, Hakusan-shi (JP); Yusuke BAMBA, Hakusan-shi (JP); Ryosuke DOMAE, Hakusan-shi (JP); Hiroshi ITO, Hakusan-shi (JP)

(73) Assignee: EIZO Corporation, Hakusan-shi, Ishikawa (JP)

(21) Appl. No.: 17/800,673

(22) PCT Filed: Feb. 10, 2021
(86) PCT No.: PCT/JP2021/005106

§ 371 Date: Aug. 18, 2022

(30) Foreign Application Priority Data
Feb. 21, 2020 (JP) 2020-028753

(51) Int. Cl. G01J 1/02; G01J 1/58; G09G 3/36

(52) U.S. Cl. CPC G01J 1/0238; G01J 1/58; G09G 3/36; G09G 2320/0233; G09G 2360/145

(57) ABSTRACT

A method for detecting emitted light from a display screen with a simple configuration and procedure without changing the position of the sensor. A method for detecting emitted light from a display screen of a display apparatus, including: a placement step of placing a photometric part including an optical sensor and a light guide member on a front surface side of the display screen, and a detection step of turning on any area of the display screen, guiding the emitted light from the area to the optical sensor by the light guide member, and detecting the emitted light with the optical sensor without changing the position of the optical sensor.

### FIELD

This invention relates to the detection of emitted light from a display screen.

### BACKGROUND

Various methods have been developed to detect emitted light from some areas of the display screen in display apparatuses. For example, Patent Literature 1 discloses measuring the emitted light from each pixel in a display apparatus in which the light source of the backlight is controlled to blink, while moving the line sensor in accordance with the timing of pixel lighting.

### Patent Literature

Patent Literature 1: Japanese Unexamined Patent Application Publication No. 2017-161754 Summary

However, the configuration described in Patent Literature 1 uses a movable sensor, which requires control of the sensor’s movement, making the circuit configuration complex and requiring operation for the movement.

The present invention was made in view of these circumstances, and an object of the invention is to provide a method for detecting emitted light from a display screen with a simple configuration and procedure without changing the position of the sensor.

The present invention provides a method for detecting emitted light from a display screen of a display apparatus, comprising: a placement step of placing a photometric part including an optical sensor and a light guide member on a front surface side of the display screen, and a detection step of turning on any area of the display screen, guiding the emitted light from the area to the optical sensor by the light guide member, and detecting the emitted light with the optical sensor without changing the position of the optical sensor.

With this configuration, the emitted light from any area of the display screen is guided by the light guide member provided on the front side of the display screen to the optical sensor and is detected. This allows detection of the emitted light from the display screen with a simple configuration and procedure, without using a movable sensor and without changing the position of the optical sensor.

The following are examples of various embodiments of the invention. The embodiments shown below can be combined with each other. Also, each feature independently constitutes an invention.

Preferably, the method comprising a luminance identification step for identifying a luminance corresponding to the emitted light detected in the detection step.

Preferably, the method further comprising a chromaticity identifying step to identify a chromaticity corresponding to the emitted light detected in the detecting step.

Preferably, at least one of a front surface and/or a back surface of the light guide member has a diffuse reflection structure.

Preferably, a reflection structure is formed on the front surface of the light guide member.

Preferably, the photometric part is detachable from the display apparatus.

Preferably, the method further comprising a step of causing a display device disposed on the display screen to emit light.

According to another aspect, a display apparatus capable of detecting emitted light from a display screen comprising a control unit, wherein, a photometric part including a light guide member and an optical sensor is provided on a front surface side of the display screen, the control unit is configured to turn on any area of the display screen without changing the position of the optical sensor, and the emitted light from the area is guided by the light guide member to the optical sensor and is detectable by the optical sensor.

### BRIEF DESCRIPTION OF DRAWINGS

FIG. 1A is a front perspective view of a display apparatus 10 of the first embodiment. FIG. 1B is a front view of a display part 1.

FIG. 2 is a cross-sectional view of the display part 1.

FIG. 3 is a drawing illustrating the functional configuration of the display apparatus 10.

FIG. 4 is a flow chart showing the procedure of luminance unevenness correction process.

FIG. 5A is a drawing illustrating the lighting of a display screen 4.

FIG. 5B is a drawing illustrating the detection of the emitted light from the display screen 4.

FIG. 6 is a drawing illustrating the updating process of unevenness correction data.

FIG. 7 is a cross-sectional view of the display part 1 in variation 1.

FIG. 8A is a cross-sectional view of the display part 1 in variation 2 when an electric field is applied to the light guide plate 7b.

FIG. 8B is a cross-sectional view of the display part 1 in variation 2 when no electric field is applied to the light guide plate 7b.

FIG. 9A is a cross-sectional view of variation 3 when the light guide plate 7b is provided on a part of the display screen 4.

FIG. 9B is a cross-sectional view of variation 3 when an air layer 7c is provided between a protective glass 7 and a display device 6.

FIG. 10A is a cross-sectional view of the display part 1 in variation 4 with a flat mirror 7d.

FIG. 10B is a cross-sectional view of the display part 1 in variation 4 with a curved mirror 7d.

FIG. 11 is a front view of the display part 1 in variation 5.

FIG. 12 is a drawing illustrating the process of color unevenness correction in the second embodiment.

FIG. 13 is a flow chart showing the procedure of the color unevenness correction process.

FIG. 14A is a cross-sectional view of the display part 1 for the third embodiment.

FIG. 14B is a front view of the display part 1 in accordance with the third embodiment.

FIG. 15 is a drawing illustrating the functional configuration of the display apparatus 10 and the photometric part 20 in accordance with the third embodiment.

FIG. 16A is a cross-sectional view of the display part 1 according to variation 1 of the third embodiment.

FIG. 16B is a front view of the display part 1 according to variation 1 of the third embodiment.

FIG. 17 is a cross-sectional view of display part 1 according to variation 2 of the third embodiment.

FIG. 18A is a cross-sectional view of display part 1 according to variation 3 of the third embodiment.

FIG. 18B is a front view of the display part 1 according to variation 3 of the third embodiment.

FIG. 19A is a cross-sectional view of the display part 1 according to variation 4 of the third embodiment.

FIG. 19B is a front view of the display part 1 according to variation 4 of the third embodiment.

FIG. 20 is a drawing illustrating the detection of the emitted light from the display screen 4 in variation 4.

### DETAILED DESCRIPTION

### 1. First Embodiment

### 1.1. Configuration of Display Apparatus 10

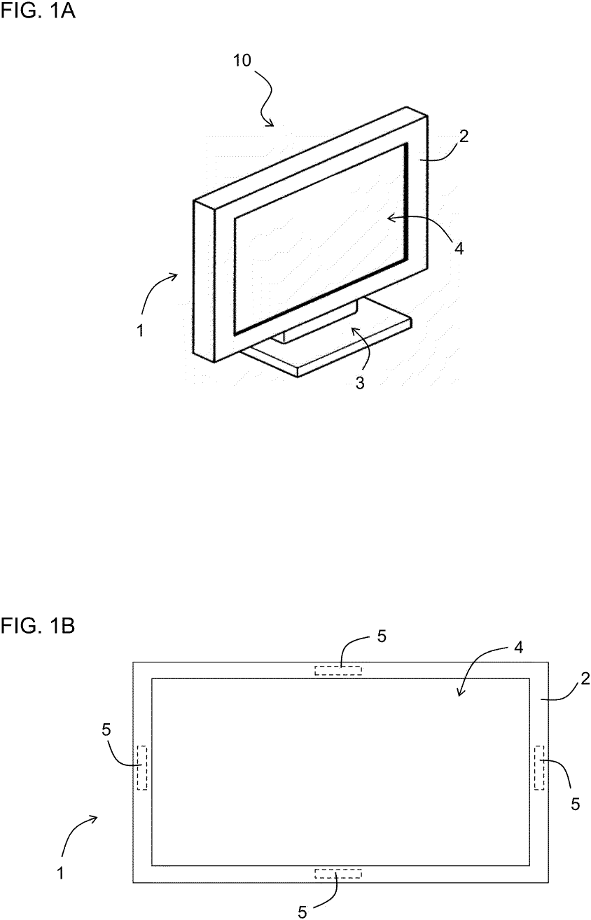

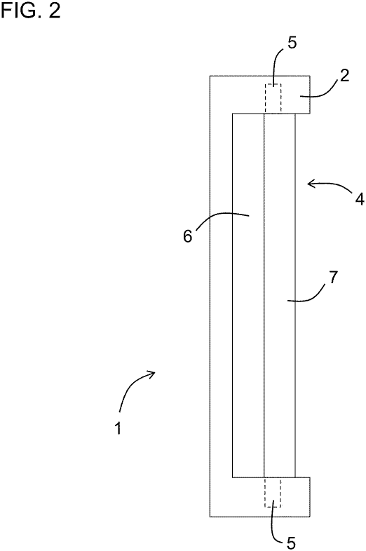

Referring to FIGS. 1 and 2, the configuration of the display apparatus 10 is described.

As shown in FIG. 1A, the display apparatus 10 is composed of a display part 1, a bezel 2, and a leg part 3. The display part 1 displays images (including still and moving images) on a display screen 4. The bezel 2 is attached from the back to the side of the display part 1 and is made of an insulating material, such as engineering plastic. Although not shown in detail, the bezel 2 is provided with a power indicator, various keypads for user operation, and a speaker. The leg part 3 is attached to the back of the bezel 2 and supports the display part 1.

As shown in FIG. 1B, an optical sensor 5 is located inside the bezel 2 at the front of the display part 1. In the display apparatus 10 of this embodiment, four optical sensors 5 are located at the top, bottom, left, and right positions inside the bezel 2 so as to surround the outer circumference of the display screen 4.

As shown in FIG. 2, the display screen 4 has a display device 6 and a protective glass 7 located on the rear side of the display part 1. The display device 6 is composed of an organic EL display panel, for example, and displays images when light emitting elements corresponding to the pixels of the display screen 4 emit light. The protective glass 7 is placed on a front surface side of the display screen 4 to protect the display device 6. As will be described in detail later, the protective glass 7 passes the emitted light from the display device 6 and also functions as a light guide member that reflects the emitted light and guides it to the optical sensors 5. In the example shown in FIG. 2, the optical sensors 5 are located on the side of the protective glass 7, but they are not limited to this example and may be located on the side of the display device 6, for example. In order to guide all the emitted light from the display device 6 to the optical sensors 5 without leaking outward, all the side surfaces of the protective glass 7 or display device 6 where the optical sensors 5 are located may be mirror-finished, except for the location of the optical sensors 5.

### 1.2. Functional Configuration of Display Apparatus 10

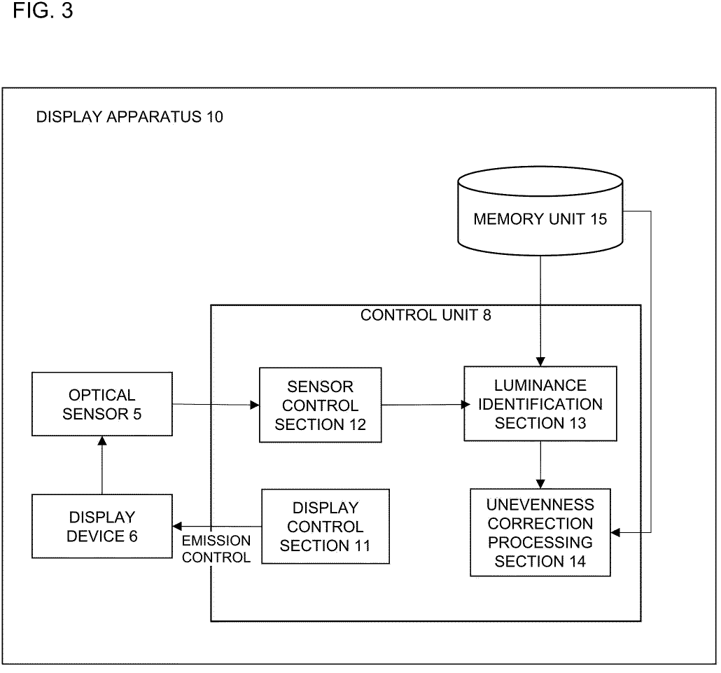

Referring to FIG. 3, the functional configuration of the display apparatus 10 will be described. As shown in FIG. 3, the display apparatus 10 has, in addition to the optical sensors 5 and display device 6 described above, a control unit 8 and a memory unit 15. The control unit 8 includes a display control section 11, a sensor control section 12, a luminance identification section 13, and an unevenness correction processing section 14.

The display control section 11 controls the emitted light from the display device 6. The sensor control section 12 identifies the intensity of the emitted light detected by the optical sensors 5. The luminance identification section 13 identifies the luminance of the emitted light detected by the optical sensors 5. The unevenness correction processing section 14 corrects the unevenness of the luminance of the display screen 4. Details of each function are described later.

Each of the above components may be realized by software or by hardware. In the case of software realization, various functions can be realized by the CPU (Central Processing Unit) executing a program. The program may be stored in the memory unit 15, which may be realized by memory, HDD (Hard Disk Drive), or SSD (Solid State Drive), or may be stored on a computer-readable, non-transitory recording medium.

Each of the above components may also be realized by so-called cloud computing by reading a program stored in an external memory. Also, for hardware realization, various circuits such as an ASIC (Application Specific Integrated Circuit), FPGA (Field Programmable Gate Array), or DRP (Dynamic Reconfigurable Processor).

### 1.3. Updating Process of Correction Data for Luminance Unevenness

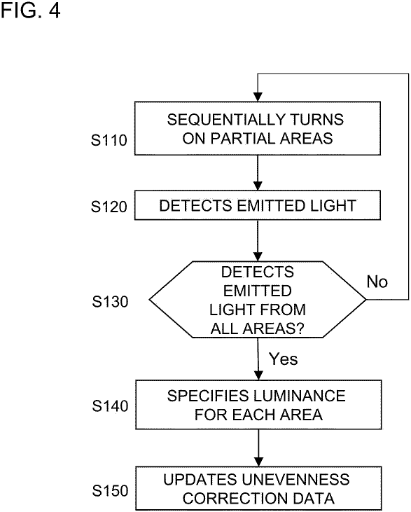

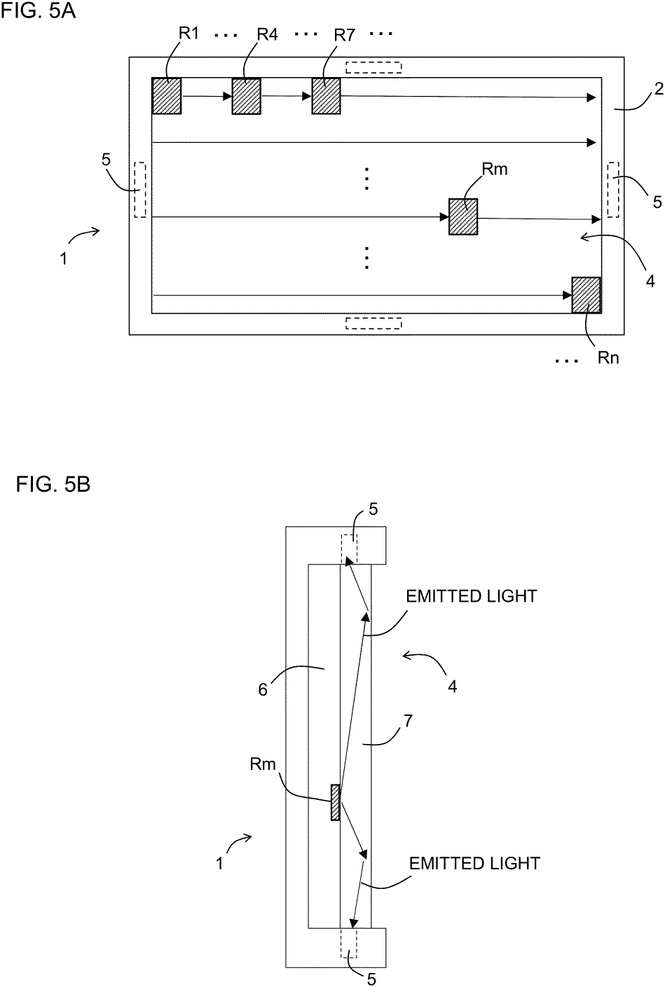

Referring to FIGS. 4 to 6, the updating process of correction data for luminance unevenness on the display apparatus 10 is explained. As shown in FIG. 4, first, in step S110, the display control section 11 turns on partial areas of the display screen 4 and emits the emitted light. Specifically, as shown in FIG. 5A, the display control section 11 causes a part of the display device 6 to emit light, sequentially from R1, the upper left area of the display screen 4, to Rn, the lower right area of the display screen 4.

Here, the shape, size, and number of sequentially turned-on areas may be set as desired, but it is preferable to set them so that they cover the entire display screen 4. The areas may be set to be mutually exclusive, or they may be set to overlap each other.

In step S120, the emitted light from the turned-on area is detected by the optical sensors 5. As shown in FIG. 5B, the emitted light from the partial areas of the display screen 4 is reflected in the protective glass 7, which functions as a light guide member, and is detected by the optical sensors 5.

In step S130, the sensor control section 12 determines whether or not emitted light from all areas of the display screen has been detected. If emitted light from all areas is detected (Yes in step S130), step S140 is performed. If emitted light from all areas is not detected (No in step S130), steps S110 and S120 are repeated.

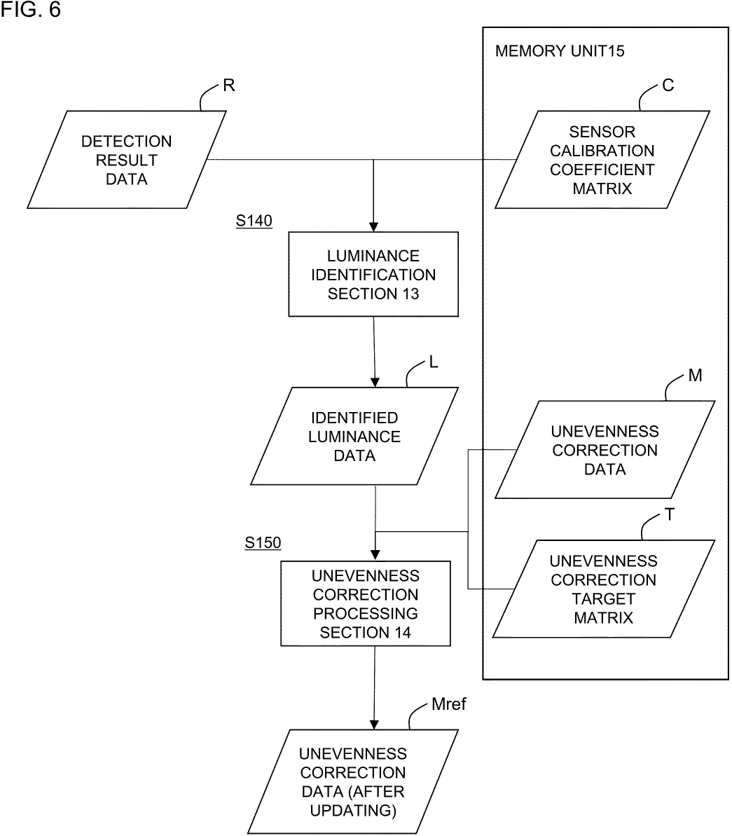

In step S140, the luminance identification section 13 identifies the luminance of each turned-on area based on the detection results of the optical sensors 5 (i.e., the detected emitted light intensity). As shown in FIG. 6, the sensor calibration coefficient matrix C is stored in the memory unit 15. The sensor calibration coefficient matrix C has a correspondence between the luminance value for each area of the display screen 4 measured with a luminance meter or the like at the time of manufacture of the display apparatus 10 and the detection value of the optical sensors 5 detection values when the area is turned on. The luminance identification section 13 identifies the luminance of each turned-on area of the display screen 4 based on the detection result data R of the optical sensors 5 and the sensor calibration coefficient matrix C.

In step S150, the unevenness correction processing section 14 updates the unevenness correction data M. As shown in FIG. 6, the memory unit 15 has the unevenness correction data M and an unevenness correction target matrix T. The unevenness correction data M is a data related to the amount of correction for the luminance unevenness of each area of the display screen 4 measured at the time of manufacture of the display apparatus 10, and is referred to when performing luminance unevenness correction for any image data. The unevenness correction target matrix T is a data that defines the amount of luminance unevenness (the rate of change of luminance relative to the reference value) that should be targeted for each area of the display screen 4. The updated unevenness correction data Mref can be represented by the following equation (1). The updated unevenness correction data Mref is used for subsequent correction of luminance unevenness. [Equation 1]

$$M r e f = \frac{T}{L} \times M$$

As described above, the display apparatus 10 in this embodiment is provided with the protective glass 7 as a light guide member, the optical sensors 5, and the control unit 8. The protective glass 7 is installed on the front surface side of the display screen 4, and the optical sensors 5 are installed on the outer periphery of the display screen 4. The control unit 8 turns on partial areas of the display screen 4. The emitted light from the area is guided to the optical sensors 5 by the protective glass 7 as a light guide member, and is detected by the optical sensors 5.

This configuration allows detection of emitted light from the display screen with a simple configuration and procedure. Also, based on the detection result of the emitted light, the correction data for luminance unevenness of the display screen 4 can be updated, enabling appropriate correction processing for luminance unevenness.

### 1.4. Variation 1

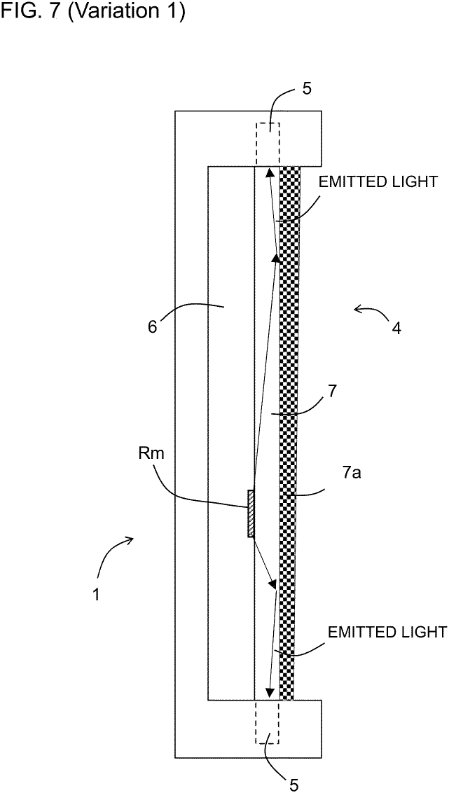

Referring to FIG. 7, a variation 1 of the first embodiment will be described. As shown in FIG. 7, on the front surface of the protective glass 7 in variation 1, a pattern 7a is formed to reflect the emitted light from the display device 6. The pattern 7a may be formed by dot printing on the front surface of the protective glass 7 or may be realized by attaching a lens structure to the front surface of the protective glass 7. This configuration allows for the specific realization of a light guiding member that guides the emitted light from the display device 6 to the optical sensors 5.

### 1.5. Variation 2

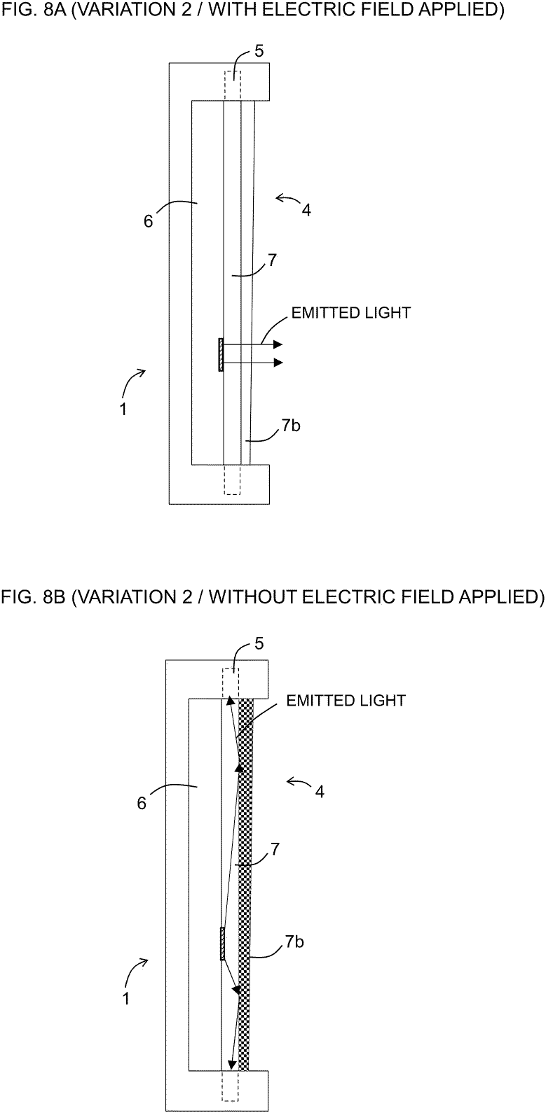

Referring to FIGS. 8A and 8B, variation 2 will be described. As shown in FIGS. 8A and 8B, on the front surface of the protective glass 7 in variation 2, the light guide plate 7b is attached to change the passage and reflection of the emitted light as an electric field is applied. The light guide plate 7b is realized, for example, in PDLC (Polymer Dispersed Liquid Crystal) glass.

In this case, as shown in FIG. 8A, by applying an electric field to the light guide plate 7b, the emitted light from the display device 6 is passed through the protective glass 7 and the light guide plate 7b. In contrast, as shown in FIG. 8B, when the application of an electric field to light guide plate 7b is stopped, the emitted light from the display device 6 is reflected by light guide plate 7b and guided to the optical sensor 5.

With this configuration, during normal use, the electric field can be applied to the light guide plate 7b to make the display screen 4 visible. Also, during specific operations such as detecting the emitted light from the display device, the application of an electric field to the light guide plate 7b can be stopped and the emitted light from the display device 6 can be guided to the optical sensor 5. This allows separate control for the use of the device.

### 1.6. Variation 3

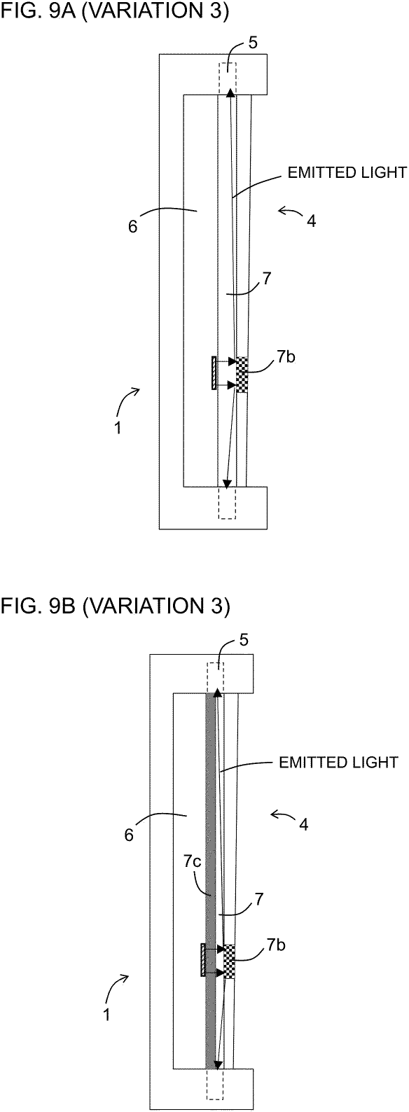

Referring to FIGS. 9A and 9B, variation 3 will be described. As shown in FIG. 9A, in variation 3, by applying an electric field only to a part of the light guide plate 7B, the area in which the emitted light is reflected is configured to be changeable. This configuration allows the area that reflects the emitted light to be changed in accordance with the area to be turned on. In the example shown in FIG. 9B, an air layer 7c is provided between the protective glass 7 and the display device 6. By providing an air layer 7c with a different refractive index, it becomes easier to transmit the emitted light reflected by the light guide plate 7b within the protective glass 7.

### 1.7. Variation 4

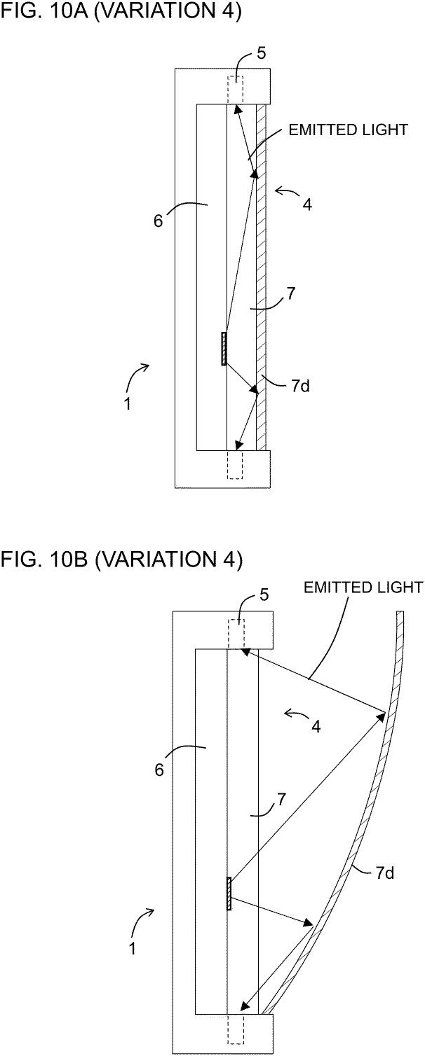

Referring to FIG. 10A and FIG. 10B, variation 4 will be described. As shown in FIGS. 10A and 10B, on the front surface of the protective glass 7 in variation 4, a mirror 7d is provided to reflect the emitted light from the display device 6 as the light guide member. The mirror 7d is detachable and can be detached during normal use to allow viewing of the display screen.

FIG. 10A illustrates a flat mirror 7d. On the other hand, FIG. 10B illustrates the installation of a curved mirror 7d. These configurations allow to realize a light guide member that guides the emitted light from the display device 6 to the optical sensors 5 using general-purpose products such as flat or curved mirrors.

### 1.8. Variation 5

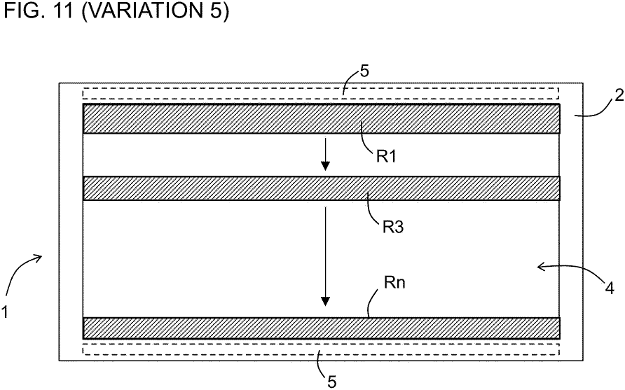

Referring to FIG. 11, variation 5 will be described. As shown in FIG. 11, in variation 5, line sensors as optical sensors 5 are installed inside the bezel 2 above and below the display screen 4. In this case, partial areas R1 to Rn of the display screen 4 that are turned on by the control unit 8 should span the left and right sides of the display screen 4. This configuration allows the control unit 8 to quickly perform the process of turning on the area of the display part 1 and detecting the emitted light (step S110 to step S130 in FIG. 4).

### 2. Second Embodiment

### 2.1. Configuration

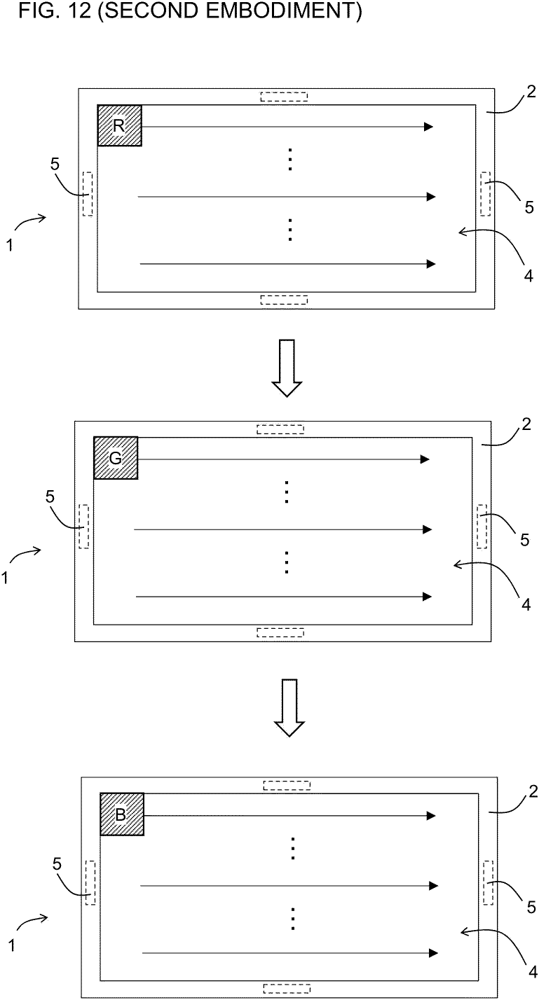

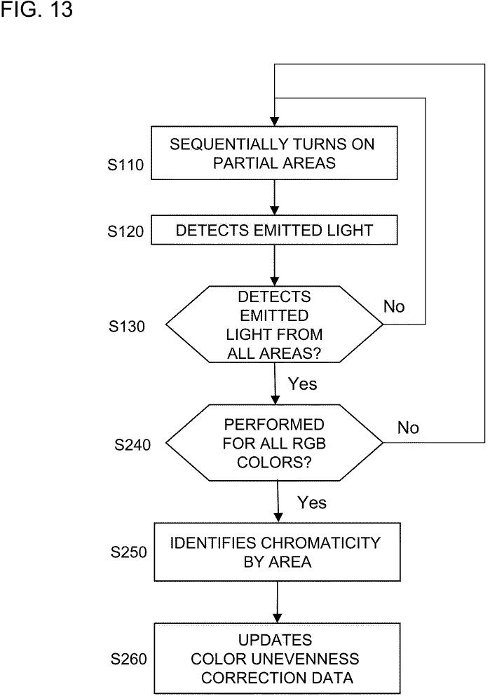

Referring to FIGS. 12 and 13, the second embodiment of the present invention will be described. The second embodiment differs from the first embodiment in that the invention includes a chromaticity identification step to identify a chromaticity corresponding to the emitted light detected by the optical sensors 5. The following description will focus on the differences from the first embodiment.

In the second embodiment, as shown in FIGS. 12 and 13, the control unit 8 emits each of the R (Red), B (Blue), and G (Green) light emitting elements of the display device 6 for each area and detects the light intensity of each color with the optical sensors 5 (steps S110 to S240 in FIG. 13).

In step S250, the control unit 8 compares the previously measured R, G, and B light intensity and the newly acquired R, G, B detection results to identify the chromaticity of R, G, B for each detected area. In step S260, the control unit 8 processes the update of the color unevenness correction data so that the ratios of R, G, and B are the same. This allows the display color to be adjusted to the target color.

### 2.2. Variation

As a variation of the second embodiment, three types of optical sensors 5 may be arranged for each of the R, G, and B colors. In this case, by placing one of the R, G, or B filters in front of the photosensitive area of the optical sensors 5, for example, the sensors can be configured as sensors for each of the R, G, and B colors. In this way, by measuring the luminous intensity in each color using the optical sensors 5 corresponding to the color, it is possible to accurately measure the chromaticity even when the chromaticity of each R, G, and B has changed over time.

### 3. Third Embodiment

### 3.1. Configuration

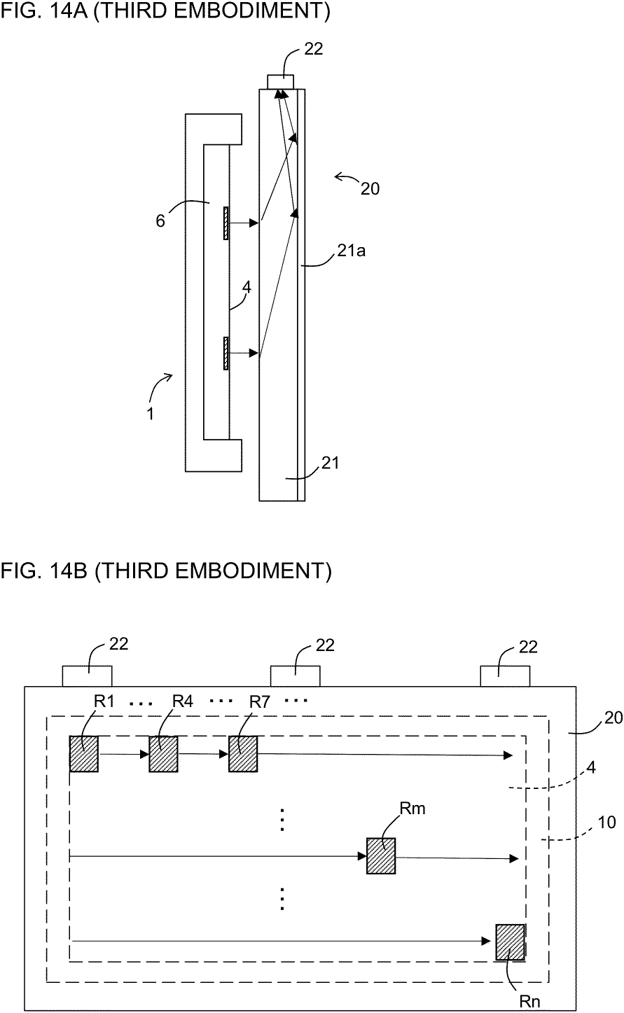

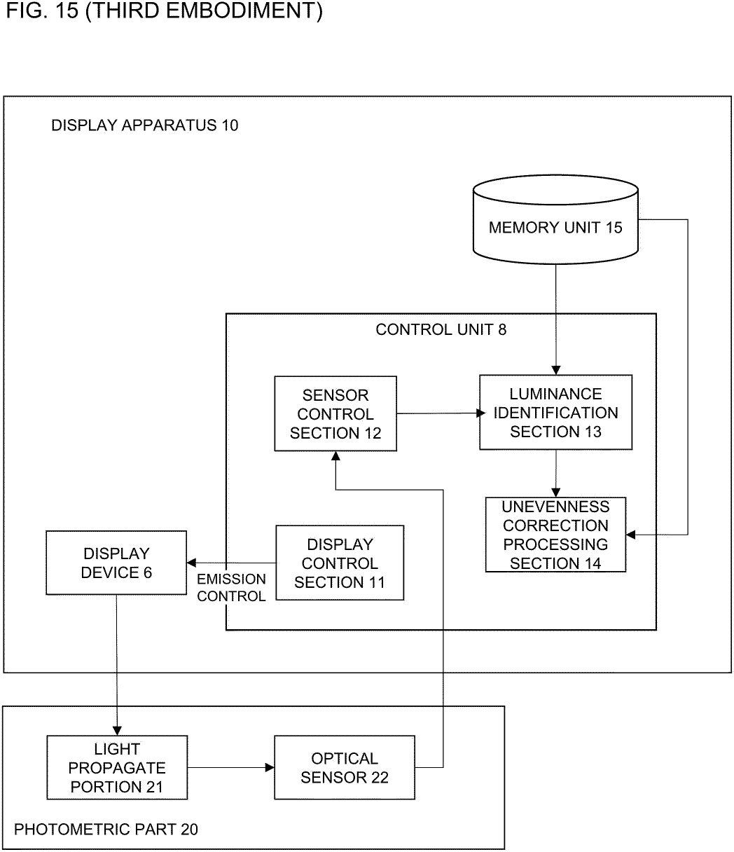

Referring to FIGS. 14 and 15, the third embodiment of the present invention will be described. The third embodiment differs from the first embodiment in that it uses a photometric part 20 detachably placed on the front surface side of the display screen 4 to detect the emitted light from the display device 6. The following description will focus on the differences from the first embodiment.

As shown in FIGS. 14 and 15, the photometric part 20 is used in the third embodiment. The photometric part 20 has a light propagate portion 21 as a light guiding member and an optical sensors 22. The photometric part 20 is formed in a flat rectangular shape as an example. As shown in FIG. 14B, the photometric part 20 is preferably provided with an area larger than the display screen 4 when viewed from the front, and more preferably provided with an area larger than the display apparatus 10.

The light propagate portion 21 is composed of glass or the like, and the front surface 21a of the light propagate portion 21 has a mirror treatment. As a result, the light propagate portion 21 passes the emitted light from the display device 6 and also functions as a light guide member that reflects the emitted light and guides it to the optical sensors 5. As an example, the optical sensors 5 are provided at a plurality of predetermined locations (three in the example shown in FIG. 14) on the top surface of the photometric part 20.

The light propagate portion 21 may further be provided with a structure to control the reflection direction of the emitted light. The surface of the display device 6 may also be provided with a structure to diffuse the emitted light.

Thus, in the third embodiment, the photometric part 20, which is independent from the display apparatus 10, is used to detect the emitted light from any area of the display screen 4 by the light propagate portion 21 propagating the light to the optical sensor 22. In this way, since the photometric part 20 is configured to be detachable from the display apparatus 10, it is possible to apply the technical concept of the present application to existing display apparatuses of various sizes. Also, since the optical sensors 22 are provided at a predetermined unchanged position in the photometric part 20, a mechanism for moving the optical sensors 22 and a process for controlling the movement of the optical sensors 22 are not required.

### 3.2. Variation 1

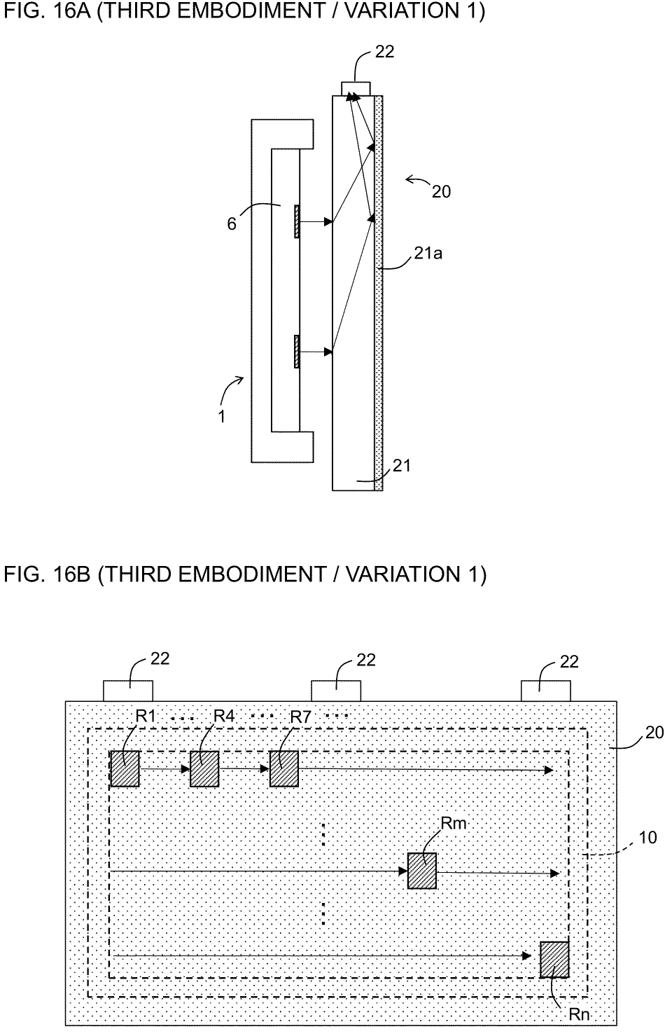

Referring to FIG. 16, variation 1 of the third embodiment will be described. In the photometric part 20 in Variant 1, the front surface 21a of the light propagate portion 21 is surface treated with a diffuse reflection structure. Such surface treatments can promote diffusion of the emitted light within the light propagate portion 21, and thus facilitates guiding the emitted light to the optical sensors 22. The diffuse reflective structure can use surface treatments such as dot printing and/or (or) imparting a lens array shape. In these cases, the shape, size, and density of the dot printing pattern and lens array can be designed appropriately, taking into account the shape of the light propagate portion 21 and its position with the optical sensors 22.

### 3.3. Variation 2

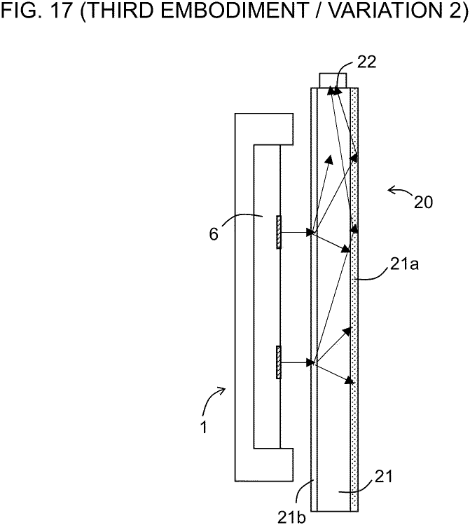

Referring to FIG. 17, variation 2 of the third embodiment will be described. In the photometric part 20 in Variant 2, the back surface 21b of the light propagate portion 21 is surface treated with a diffuse reflection structure. Specifically, a diffusion sheet may be attached, or dots may be printed or a lens array shape may be given. Such surface treatments can further promote the diffusion of the emitted light within the light propagate portion 21, and thus facilitate the design for guiding the light to the optical sensors 22.

### 3.4. Variation 3

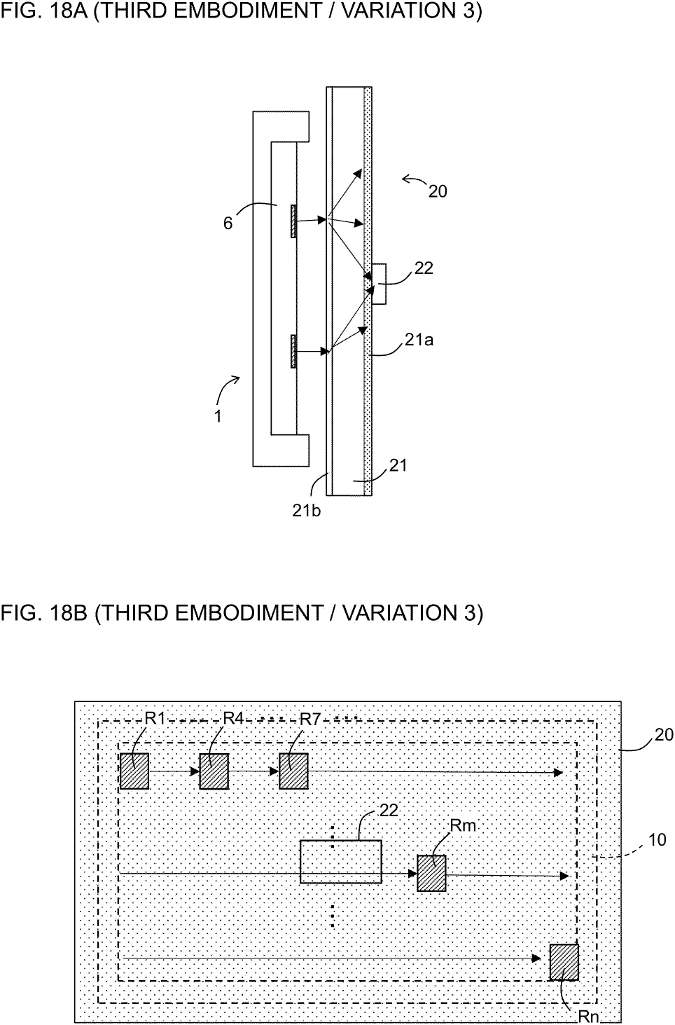

Referring to FIG. 18, variation 3 of the third embodiment will be described. In variation 3, the optical sensor 22 is located on the front surface of the photometric part 20. One optical sensor 22 may be placed in the center of the front face of the photometric part 20 as shown in FIG. 18, or it may be placed elsewhere on the front face of the photometric part 20. In this case, the front surface 21a and the back surface 21b of the light propagate portion 21 should be surface treated with diffuse reflection structure. On the other hand, the position in the front surface 21a of the light propagate portion 21 where the optical sensor 22 is located should be allowed to pass through the emitted light without surface treatment. Thus, by adjusting the diffuse reflection of the outgoing light in the light propagate portion 21 accordingly, the emitted light can also be detected by the optical sensor 22 placed in front of the photometric part 20 without changing its position.

### 3.5. Variation 4

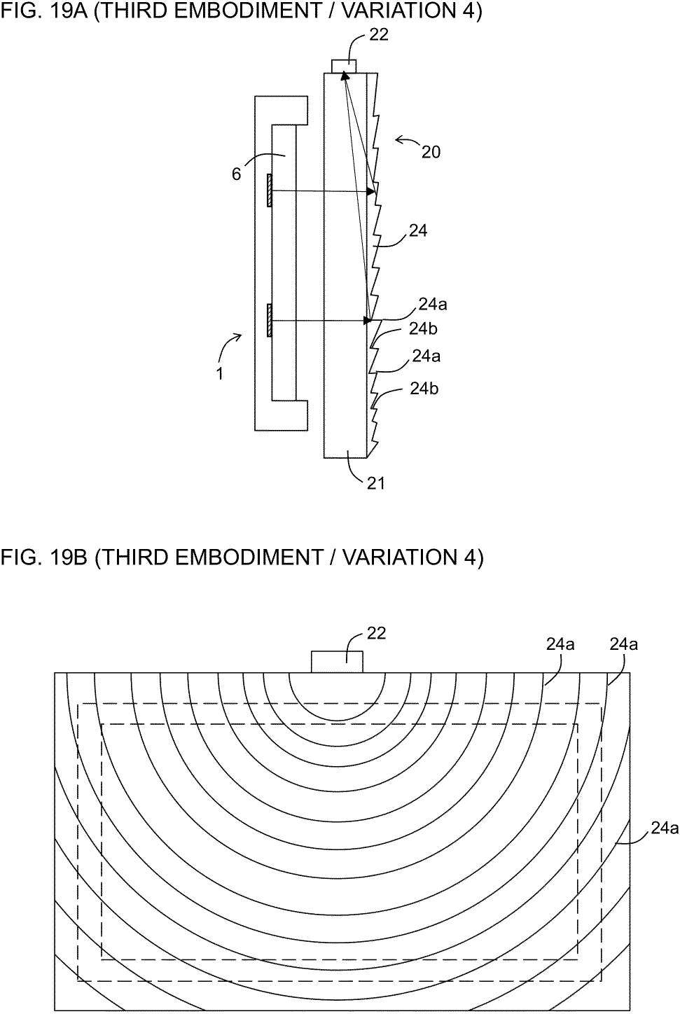

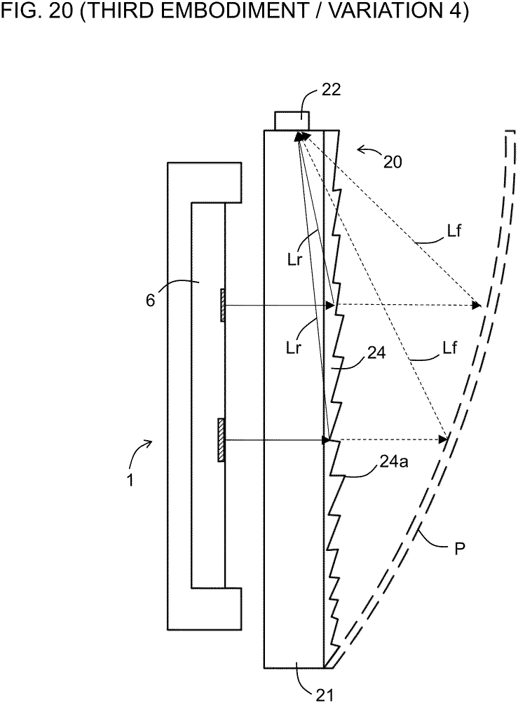

Referring to FIGS. 19 and 20, variation 4 of the third embodiment will be described. The photometric part 20 in variation 4 has a concave-convex Fresnel mirror 24 formed on the front surface. The Fresnel mirror 24 has alternating apex 24a and groove 24b, and as shown in FIG. 19B, is formed on a circular arc centered on the optical sensor 22 when viewed from the front.

In variation 4, as shown in FIG. 20, the emitted light from any area of the display device 6 is passed through the light propagate portion 21, reflected by the Fresnel mirror 24, and guided through the trajectory Lr to the optical sensor 22. Here, because the Fresnel mirror 24 is formed, the emitted light is reflected at the virtual parabolic surface P and can be guided to the optical sensor 22. With this configuration, one optical sensor 22 is placed in the center of the top surface of the photometric part 20, and thus facilitate the design for guiding the emitted light from the display device 6 to the optical sensor 22.

### 4. Other Embodiments

The implementation of the present invention is not limited to the above embodiments. For example, the number, shape, and location of the optical sensors 5 are not limited to the above. As an example, there may be only one optical sensor 5, or it may be located on the bezel instead of inside the bezel.

In the above embodiment, the display screen 4 was realized by the light emitting elements of the display device 6, but it is not limited to this configuration. For example, the technical ideas of the present disclosure can be applied to so-called liquid crystal panels in which light from the backlight is blocked by the liquid crystal part.

In variation 4 of Embodiment 1 above, a detachable mirror 7d is used as a light guide member, but the light guide member in other forms may also be detachable.

In the third embodiment, the photometric part 20 may be provided with a control unit 8 and perform some or all of the functions of the sensor control section 12 or the luminance identification section 13. The photometric part 20 may also be a non-detachable arrangement, i.e., a fixed arrangement.

Furthermore, this invention can also be realized as a program that causes the control unit 8 to perform each of the functions described above.

Furthermore, the invention may be realized as a computer-readable, non-transitory recording medium storing the above-mentioned program.

Various embodiments of the present invention have been described, but these are presented as examples and are not intended to limit the scope of the invention. The embodiments may be variously omitted, replaced, or modified to the extent that the gist of the invention is not departed from. Said embodiments and variations thereof are included in the scope and gist of the invention, as well as in the invention described in the claims and its equivalents.

### Reference Signs List

1: display part, 2: bezel, 3: leg part, 4: display screen, 5: optical sensor, 6: display device, 7: protective glass, 7a: pattern, 7b: light guide plate, 7c: air layer, 7d: mirror, 8: control unit,10: display apparatus, 11: display control section, 12: sensor control section, 13: luminance identification section, 14: unevenness correction processing section, 15: memory unit, 20: photometric part, 21: light propagate portion, 21a: front surface, 21b: back surface, 22: optical sensor, 24: Fresnel mirror, 24a: apex, 24b: groove

1. A method for detecting emitted light from a display screen of a display apparatus, comprising:
a placement step of placing a photometric part including an optical sensor and a light guide member on a front surface side of the display screen, and
a detection step of turning on any area of the display screen, guiding the emitted light from the area to the optical sensor by the light guide member, and detecting the emitted light with the optical sensor without changing the position of the optical sensor, wherein
the photometric part is detachable from the display apparatus.

2. The method according to claim 1 further comprising a luminance identification step for identifying a luminance corresponding to the emitted light detected in the detection step.

3. The method according to claim 1 further comprising a chromaticity identifying step to identify a chromaticity corresponding to the emitted light detected in the detecting step.

4. The method according to claims 1, wherein
at least one of a front surface and/or a back surface of the light guide member has a diffuse reflection structure.

5. The method according to claims 1, wherein
a reflection structure is formed on the front surface of the light guide member.

6. (canceled)

7. The method according to claim 1 further comprising a step of causing a display device disposed on the display screen to emit light.

8. A display apparatus capable of detecting emitted light from a display screen comprising a control unit, wherein,
a photometric part including a light guide member and an optical sensor is provided on a front surface side of the display screen,
the control unit is configured to turn on any area of the display screen without changing the position of the optical sensor,-and
the emitted light from the area is guided by the light guide member to the optical sensor and is detectable by the optical sensor,
and the photometric part is detachable from the display apparatus.
